(19) United States
(12) Patent Application Publication
(10) Pub. No.: US 2023/0232444 A1
(43) Pub. Date: Jul. 20, 2023

(54) METHOD AND APPARATUS FOR DETERMINING RANDOM ACCESS CONFIGURATION, COMMUNICATION DEVICE, AND STORAGE MEDIUM

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 17/928,789

(22) PCT Filed: Jun. 3, 2020
(86) PCT No.: PCT/CN2020/094246

§ 371 Date: Nov. 30, 2022

(51) Int. Cl. H04W 74/00; H04W 74/08; H04W 72/542

(52) U.S. Cl. CPC H04W 74/004; H04W 74/0833; H04W 74/006; H04W 72/542

(57) ABSTRACT

A method for determining random access configuration of a terminal, performed by the terminal. The method includes: receiving an obtaining request, sent by a base station, for a historical random access record; and sending the historical random access record associated with the obtaining request to the base station.

### CROSS REFERENCE TO RELATED APPLICATION

The present application is a U.S. National Stage of International Application No. PCT/CN2020/094246, filed on Jun. 3, 2020, the contents of all of which is incorporated herein by reference in their entirety for all purposes.

### BACKGROUND

In order to extend the 5th generation new radio (5G NR) technology to an unlicensed frequency band, the 3rd generation partnership project (3GPP) passes a 5G research project “research on access to an unlicensed spectrum based on a new radio,” to make the new radio satisfy the regulation requirements of the unlicensed frequency band through the research of the project, and further to ensure peaceful coexistence of the new radio with other access technologies working on the unlicensed frequency band.

### SUMMARY

According to a first aspect of examples of the disclosure, provided is a method for determining a random access configuration of a terminal. The method is performed by the terminal and includes:

receiving an obtaining request, sent by a base station, for a historical random access record; and sending the historical random access record associated with the obtaining request to the base station.

According to a second aspect of examples of the disclosure, provided is a method for determining a random access configuration of a terminal. The method is performed by a base station and includes:

sending an obtaining request for a historical random access record to the terminal; and

receiving the historical random access record associated with the obtaining request from the terminal.

According to a third aspect of examples of the disclosure, provided is a communication device. The communication device includes:

a processor; and

a memory configured to store an executable instruction of the processor;

where the processor is configured to implement the method according to any one of examples of the disclosure when operating the executable instruction.

According to a fourth aspect of examples of the disclosure, provided is a computer storage medium. The computer storage medium stores a computer-executable program, and when executed by a processor, the executable program implements the method according to any one of the examples of the disclosure.

### BRIEF DESCRIPTION OF THE DRAWINGS

FIG. 1 is a schematic structural diagram of a radio communication system.

FIG. 2 is a schematic diagram of a random access method according to an example.

FIG. 3 is a flow diagram of a method for determining a random access configuration of a terminal according to an example.

FIG. 4 is a schematic diagram of a method for determining a random access configuration of a terminal according to an example.

FIG. 5 is a flow diagram of a method for determining a random access configuration of a terminal according to an example.

FIG. 6 is a flow diagram of a method for determining a random access configuration of a terminal according to an example.

FIG. 7 is a flow diagram of a method for determining a random access configuration of a terminal according to an example.

FIG. 8 is a flow diagram of a method for determining a random access configuration of a terminal according to an example.

FIG. 9 is a flow diagram of a method for determining a random access configuration of a terminal according to an example.

FIG. 10 is a flow diagram of a method for determining a random access configuration of a terminal according to an example.

FIG. 11 is a schematic diagram of an apparatus for determining a random access configuration of a terminal according to an example.

FIG. 12 is a schematic diagram of an apparatus for determining a random access configuration of a terminal according to an example.

FIG. 13 is a block diagram of user equipment according to an example.

FIG. 14 is a block diagram of a base station according to an example.

### DETAILED DESCRIPTION

The description will here be made in detail to examples, instances of which are illustrated in the accompanying drawings. When the following description relates to the accompanying drawings, the same numbers in different accompanying drawings refer to the same or similar elements unless otherwise indicated. The implementation modes described in the following examples do not represent all implementation modes consistent with examples of the disclosure. On the contrary, they are merely instances of apparatus and methods consistent with some aspects of the examples of the disclosure as described in detail in the appended claims.

The term used in the examples of the disclosure is for the purpose of describing particular examples merely and is not intended to be restrictive of the examples of the disclosure. As used in the examples and the appended claims of the disclosure, singular forms “a” and “the” are intended to include plural forms as well, unless otherwise clearly indicated in the context. It is to be understood that the term “and/or” as used here refers to and encompasses any or all possible combinations of one or more of the associated listed items.

It is to be understood that although the terms first, second, third, etc., may be employed in the examples of the disclosure to describe various information, such information should not be limited to these terms. These terms are merely used to distinguish the same type of information from each other. For instance, first information may also be referred to as second information, and similarly, second information may also be referred to as first information, without departing from the scope of the examples of the disclosure. The word “if” as used here may be construed to mean “upon,” “when,” or “in response to determining,” depending on the context.

For purposes of brevity and ease of understanding, the term “greater than” or “less than” is used here in characterizing a size relationship. But as will be understood by those skilled in the art, the term “greater than” also encompasses the meaning of “greater than or equal to,” and “less than” also encompasses the meaning of “less than or equal to”.

The disclosure relates to the technical field of radio communication but is not limited to the technical field of radio communication, and in particular relates to a method and apparatus for determining a random access configuration of a terminal, a communication device and a storage medium.

In order to extend the 5th generation new radio (5G NR) technology to an unlicensed frequency band, the 3rd generation partnership project (3GPP) passes a 5G research project “research on access to an unlicensed spectrum based on a new radio”, to make the new radio satisfy the regulation requirements of the unlicensed frequency band through the research of the project, and further to ensure peaceful coexistence of the new radio with other access technologies working on the unlicensed frequency band. Since a listen before talk (LBT) mechanism is required by regulations in a number of countries, the new radio needs to follow the listen before talk (LBT) mechanism to work properly on the unlicensed frequency band. However, as following the listen before talk (LBT) mechanism possibly causes an increase in random access latency, in order to reduce the latency, a two-step random access mode has been employed. A terminal can perform random access in a two-step random access mode or a four-step random access mode.

However, when the terminal uses different random access modes to perform random access, random access failure often occurs, resulting in low success rate and poor stability of the random access process of the terminal.

With reference to FIG. 1, a schematic structural diagram of a radio communication system according to an example of the disclosure is shown. As shown in FIG. 1, the radio communication system is a communication system based on a cellular mobile communication technology. The radio communication system may include: several user devices 110 and several base stations 120.

The user devices 110 may be devices that provide speech and/or data connectivity for a user. Each of the user devices 110 may communicate with one or more core networks by means of a radio access network (RAN), and the user device 110 may be an Internet of Things user device, for instance, a sensor device, a mobile telephone (or referred to as a “cellular” telephone), and a computer having an Internet of Things user device, for instance, may be a stationary, portable, pocket-sized, hand-held, computer-built, or vehicle-mounted apparatus, for instance, a station (STA), a subscriber unit, a subscriber station, a mobile station, a mobile, a remote station, an access point, a remote terminal, an access terminal, a user terminal, a user agent, a user device, or user equipment. Alternatively, each of the user devices 110 may be a device of an unmanned aerial vehicle. Alternatively, each of the user devices 110 may be an in-vehicle device, for instance, an electronic control unit with a radio communication function, or a radio user device to which an electronic control unit is externally connected. Alternatively, each of the user devices 110 may be a roadside device, for instance, a street lamp, a signal lamp, another roadside device, etc. with the radio communication function.

Each of the base stations 120 may be a network-side device in the radio communication system. The radio communication system may be the 4th generation mobile communication (4G) system, also referred to as a long term evolution (LTE) system; and alternatively, the radio communication system may also be a 5G system, also referred to as a new radio (NR) system or a 5G NR system. Alternatively, the radio communication system may also be a next generation system consecutive to the 5G system. An access network in the 5G system may be referred to as a new generation-radio access network (NG-RAN).

Each of the base stations 120 may be an evolved Node B (eNB) used in a 4G system. Alternatively, each of the base stations 120 may also be a next-generation Node B (gNB) using a centrally distributed architecture in a 5G system. When each of the base station 120 uses the centrally distributed architecture, it typically includes a central unit (CU) and at least two distributed units (DU). The central unit is provided with protocol stacks of a packet data convergence protocol (PDCP) layer, a radio link control (RLC) layer and a media access control (MAC) layer; and each distributed unit is provided with a protocol stack of a physical (PHY) layer. Examples of the disclosure are not limited to the specific implementation modes of the base station 120.

A radio connection may be established between the base stations 120 and the user devices 110 by means of radio air interfaces. In different implementation modes, the radio air interface is a radio air interface based on a 4th generation mobile communication network technology (4G) standard; alternatively, the radio air interface is a radio air interface based on a 5th generation mobile communication network technology (5G) standard, for instance, the radio air interface is a new radio; and alternatively, the radio air interface may also be a radio air interface based on a 5G-based next generation mobile communication network technology standard.

In some examples, an end to end (E2E) connection may also be established between the user devices 110, for instance, vehicle to vehicle (V2V) communication, vehicle to infrastructure (V2I) communication, vehicle to pedestrian (V2P) communication, and other scenes in vehicle to everything (V2X).

The above user device may be considered as the terminal of the following examples.

In some examples, the above radio communication system may further include a network management device 130.

The several base stations 120 are each connected to the network management device 130. The network management device 130 may be a core network device in the radio communication system, for instance, the network management device 130 may be a mobility management entity (MME) in an evolved packet core (EPC). Alternatively, the network management device may be another core network device, for instance, a serving gateway (SGW), a public data network gateway (PGW), a policy and charging rules function (PCRF), a home subscriber server (HSS), etc. An implementation form of the network management device 130 is not limited to the examples of the disclosure.

To facilitate understanding of any one of the examples of the disclosure, first, a scene of random access is described by an example.

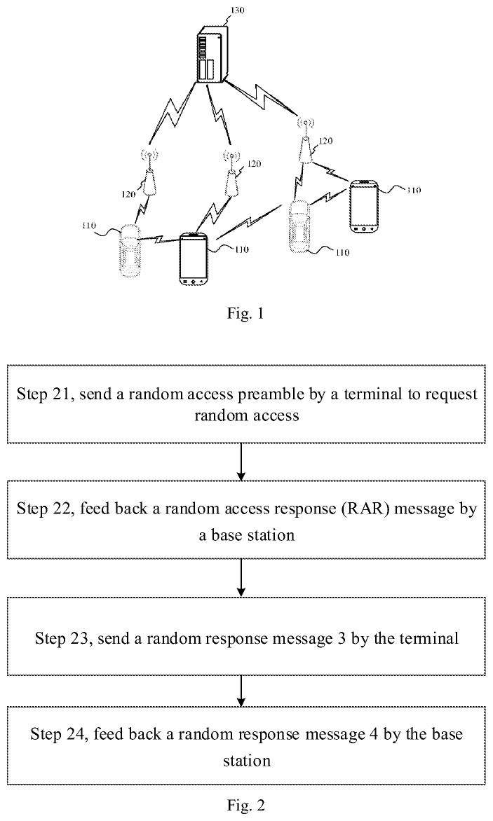

In a 5G system, random access is divided into contention-based random access and non-contention-based random access. With reference to FIG. 2, the contention-based random access includes the following 4 steps:

Step 21, send a random access preamble by a terminal to request random access.

Step 22, feed back a random access response (RAR) message by a base station. Here, the terminal decodes the random access response (RAR) message by using a random access radio network temporary identifier (RA-RNTI).

Step 23, send a random response message 3 by the terminal. The random response message 3 may include a temporary cell radio network temporary identifier (TC-RNTI).

Step 24, feed back a random response message 4 by the base station. The random response message 4 includes a cell radio network temporary identifier (C-RNTI).

On 5G unlicensed spectrum standalone networking design, a listen before talk (LBT) mechanism needs to be followed. That is, in a random access process, no matter whether uplink data is transmitted or downlink data is transmitted, a sending end needs to monitor a channel before sending the data. If no available time-frequency resource is monitored, the transmission is discarded, and then a next time-frequency resource is monitored. In this way, a latency may increase so as to influence the efficiency of random access. Thus, one possible solution is to implement the contention-based random access within two steps. For instance, information in step 1 and step 3 is merged into a message A to be sent. Information in step 2 and step 4 is merged into a message B to be sent. In some examples, the base station may support both 2-step contention random access and 4-step contention random access, or only 4-step contention random access.

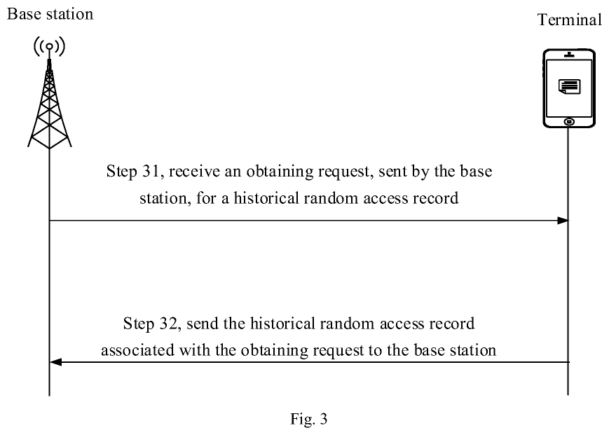

As shown in FIG. 3, an example provides a method for determining a random access configuration of a terminal. The method is applied to the terminal and includes:

Step 31, receive an obtaining request, sent by a base station, for a historical random access record.

In an example, the terminal may be, but is not limited to, a mobile phone, a wearable device, a vehicle-mounted terminal, a road side unit (RSU), a smart home terminal, an industrial sensing device and/or a medical device, etc.

In an example, the base station is an interface device for the terminal to access a network. The base station may be various types of base stations, for instance, a 3G base station, a 4G base station, a 5G base station, or other evolved base station.

In an example, the random access types of the terminal include a two-step random access type and a four-step random access type. An access time delay of the two-step random access is less than that of the four-step random access. An access rate of the two-step random access is greater than that of the four-step random access.

In an example, when a service of the terminal is a low-latency and/or high-rate service, the base station may configure the terminal to access a channel by means of two-step random access so as to send data to the base station.

In an example, the low-latency and/or high-rate service may be a service of ultra-high definition video, video conferencing, 3D gaming, etc. in an enhanced mobile broadband scene.

In another example, the low-latency and/or high-rate service may further be a service of Internet-of-Vehicles, industrial control, telemedicine, etc. in a low-latency and high-reliability scene.

In an example, the base station may configure the terminal to support the two-step random access type and/or configure the terminal to support the four-step random access type.

In an example, when the terminal supports both the two-step random access type and the four-step random access type, the two-step random access type may be preferentially used for random access.

In an example, the terminal receives an obtaining request, sent by a base station, for a historical random access record when the terminal is in a radio resource control (RRC) connection state.

In an example, information contained in the historical random access record includes one or more of the following:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the historical random access record may be recorded according to time. For instance, at time point A, the terminal attempts to access a base station with an identity document X1 by means of four-step random access, and the terminal records the following information: time information about time point A; information that the terminal selects the four-step random access type for random access; information that measured reference signal receiving power (RSRP) of a downlink loss reference is a value a; information that a reference signal receiving power (RSRP) threshold of the downlink loss reference selected by the currently set random access type is value b; information about a result of current successful random access; information that the identity document (ID) of the accessed base station is X1; information that the random access preamble selected for current random access is preamble Q1; and information the random access resource selected by the current random access is resource Z1. Different random access types use different preambles. The random access resource is a time-frequency domain resource used during random access. The identity document (ID) of the base station is configured to uniquely identify one base station.

In an example, the historical random access record may further be recorded according to the number of times of random access. For instance, when the terminal attempts to access a base station with an identity document X1 by means of two-step random access for the tenth time, the terminal records the following information: information that the terminal selects the two-step random access type for random access for the tenth time; information that measured reference signal receiving power (RSRP) of a downlink loss reference is a value a; information that a reference signal receiving power (RSRP) threshold of the downlink loss reference selected by the currently set random access type is value b; information about a result of current failed random access; information that the identity document (ID) of the accessed base station is X2; information that the random access preamble selected for current random access is preamble Q2; and information the random access resource selected by the current random access is resource Z2. Different random access types use different preambles. The random access resource is a time-frequency domain resource used during random access. The identity document (ID) of the base station is configured to uniquely identify one base station.

In an example, the reference signal receiving power (RSRP) of the downlink loss reference during random access may be receiving the power of a reference signal of the downlink loss reference measured by the terminal. The reference signal receiving power (RSRP) of the downlink loss reference may be an average of the reference signal received power (RSRP) of the downlink loss reference measured a plurality of times.

In an example, different random access types correspond to different reference signal receiving power (RSRP) thresholds of the downlink loss reference.

In an example, a reference signal receiving power (RSRP) threshold of a downlink loss reference corresponding to a two-step random access type is greater than a reference signal receiving power threshold of a downlink loss reference corresponding to a four-step random access type. In this way, since a condition of the reference signal receiving power (RSRP) threshold of the downlink loss reference corresponding to the four-step random access type may be satisfied more easily, the terminal may preferentially use the four-step random access type for random access.

In an example, a reference signal receiving power (RSRP) threshold of a downlink loss reference is a first threshold. When a measured reference signal receiving power (RSRP) of the downlink loss reference is greater than the first threshold, a two-step random access type is used for random access. When the measured reference signal receiving power (RSRP) of the downlink loss reference is less than the first threshold, a four-step random access type is used for random access.

In another example, a reference signal receiving power (RSRP) threshold of a downlink loss reference includes a second threshold and a third threshold. The second threshold is a threshold for random access using a two-step random access type, and the third threshold is a threshold for random access using a four-step random access type, the second threshold being greater than the third threshold. In an example, when a measured reference signal receiving power (RSRP) of a downlink loss reference is less than the second threshold and greater than the third threshold, a four-step random access type is used for random access. When the measured reference signal receiving power (RSRP) of the downlink loss reference is greater than the second threshold, a two-step random access type is used for random access.

In an example, the terminal accumulatively counts the number of times of random access using the two-step random access type and the number of times of random access using the four-step random access type. For instance, in a preset period of time, the number of times of random accesses using the two-step random access type is ten, and the number of times of random accesses using the four-step random access type is fifteen.

In an example, a period of accumulatively counting may be a preset time, for instance, 24 hours.

In an example, a period of accumulatively counting may be from a point in time when the terminal attempts random access to a point in time when the terminal attempts random access successfully.

In an example, in a period of accumulative counting being 24 hours, the number of times of random access using the two-step random access type by the terminal is ten, where five times of random access fail. The number of times of random access using the four-step random access type by the terminal is fifteen, where six times a random access fail.

Step 32, send the historical random access record associated with the obtaining request to the base station.

In an example, the historical random access record is used at least for the base station to determine a random access configuration of one or more terminals.

In an example, a random access configuration may configure a reference signal receiving power (RSRP) threshold of a downlink loss reference when the terminal uses a two-step random access type or a four-step random access type for random access.

In an example, when a measured reference signal receiving the power of a downlink loss reference is greater than a reference signal receiving power threshold of a downlink loss reference corresponding to a random access type used by the terminal, the terminal may use the random access type for random access. For instance, when the terminal uses a two-step random access type for random access, a reference signal receiving power threshold of a downlink loss reference is a, a currently measured reference signal receiving power of the downlink loss reference is b, and if b>a, the terminal may use the two-step random access type for random access.

In an example, when a terminal is required to have a high random access success rate, a reference signal receiving the power threshold of a downlink loss reference may be configured as A. When the terminal is required to have a relatively low random access success rate, the reference signal receiving the power of the downlink loss reference may be configured as B. A is greater than B.

A random access configuration of one or more terminals is determined according to the historical random access record of the one or more terminals.

In an example, a random access configuration of a terminal is determined according to a historical random access record of the terminal. For instance, a random access configuration of a terminal A is determined according to a historical random access record of the terminal A.

A random access condition of a position where the terminal A is located may be known according to the historical random access record of the terminal A, so as to determine the random access configuration of the terminal according to the historical random access record of the terminal A, and better adapt to the random access condition of the position where the terminal A is located. Compared with the terminal A using a fixed random access configuration for random access, a higher success rate and better stability of random access may be achieved. In this way, a success rate of random access of each terminal is improved, and the stability of random access of each terminal is improved.

In an example, random access configurations of a plurality of terminals are determined according to a historical random access record of one terminal. For instance, according to the historical random access record of the terminal A, the random access configurations of terminals B, C and D located within the same range as the terminal A are determined. The random access configurations of A, B, C, and D are identical. The same range may be a cell.

A random access condition of a position where the terminal A is located may be known according to the historical random access record of the terminal A, so as to determine the random access configurations of the terminal A and the terminals B, C and D located within the same range as the terminal A according to the historical random access record of the terminal A. Since the terminals B, C and D are located within the same range as the terminal A, the random access conditions are similar to that of the terminal A, and the random access condition of the position where the terminal A is located may provide a reference for the terminals B, C and D. The random access configuration of the terminals B, C and D determined according to the historical random access record of the terminal A may better adapt to the random access conditions of the positions where the terminals B, C and D are located. Compared with the terminals B, C and D using a fixed random access configuration for random access, a higher success rate and the better stability of random access may be achieved. Moreover, the base station does not need to obtain a historical random access record of each terminal, so as to reduce data interaction and save system resources. In an example, a random access configuration of one terminal is determined according to historical random access records of a plurality of terminals. For instance, a random access configuration of a terminal A is determined according to historical random access records of terminals A, B, C and D. The terminals B, C and D are located in the same range as the terminal A. The same range may be a cell.

Random access conditions of positions where the terminals B, C and D are located may be known according to the historical random access records of the terminals B, C and D, so as to determine the random access configuration of the terminal A located within the same range as the terminals B, C and D according to the historical random access records of the terminals B, C and D. Since the terminals B, C and D are located within the same range as the terminal A, the random access conditions are similar to that of the terminal A, and the random access conditions of the positions where the terminals B, C and D are located may provide a reference for the terminal A to determine the random access configuration. The random access configuration of the terminal A determined according to the historical random access records of the terminals B, C and D may better adapt to the random access condition of the position where the terminal A is located. Compared with the terminals B, C, and D using fixed random access configurations for random access, a higher success rate and the better stability of random access may be achieved. Moreover, it is more accurate to determine the random access configuration of the terminal A based on the historical random access records of a plurality of terminals within the same range as the terminal A. In an example, random access configurations of a plurality of terminals are determined according to historical random access records of the plurality of terminals. For instance, random access configurations of terminals A, B, C, and D are determined according to historical random access records of the terminals A, B, C and D. The random access configurations of A, B, C, and D are identical. The terminals A, B, C and D may be located within the same range. The same range may be a cell.

Random access conditions of positions where the terminals A, B, C, and D are located may be known according to the historical random access records of the terminals A, B, C, and D, so as to determine the random access configurations of the terminals A, B, C, and D according to the historical random access records of the terminals A, B, C, and D. Compared with the terminals B, C, and D using fixed random access configurations for random access, a higher success rate and better stability of random access may be achieved.

In an example, the random access configuration includes one or more of the following: a configuration of a random access type selected by the terminal; and a configuration of a reference signal receiving power (RSRP) threshold of a downlink loss reference associated with random access.

In an example, the base station instructs the terminal to use a two-step random access type for random access. However, in the past 24 hours, during ten two-step random access attempts by the terminal, eight times a random access fails, and in this case, the base station may adjust the two-step random access type for random access to the four-step random access type for random access for the terminal.

In an example, a reference signal receiving power (RSRP) threshold of the downlink loss reference is c when the base station instructs the terminal to use the two-step random access type for random access. However, in the past 24 hours, during ten random access attempts by the terminal, eight times of random access fails. In this case, the base station may raise the reference signal receiving power (RSRP) threshold of the downlink loss reference from c to d, and c<d. The reference signal receiving power (RSRP) threshold of the downlink loss reference is raised, such that reference signal strength must be greater than the higher reference signal receiving power (RSRP) threshold d of the downlink loss reference in order to attempt to use the two-step random access type for random access, which may limit the number of times that the terminal attempts to use the two-step random access type for random access. The success rate of random access is improved.

In the examples of the disclosure, the base station may obtain a random access condition of the terminal according to the historical random access record obtained from the terminal, so as to determine a random access configuration of the terminal according to the historical random access record. Thus, the random access configuration may better adapt to a random access requirement of the terminal and/or the random access condition of a current position of the terminal. Compared with the terminal using a fixed random access configuration for random access, it has higher success rate and better stability that the terminal uses a random access configuration determined according to the historical random access record of the terminal for random access.

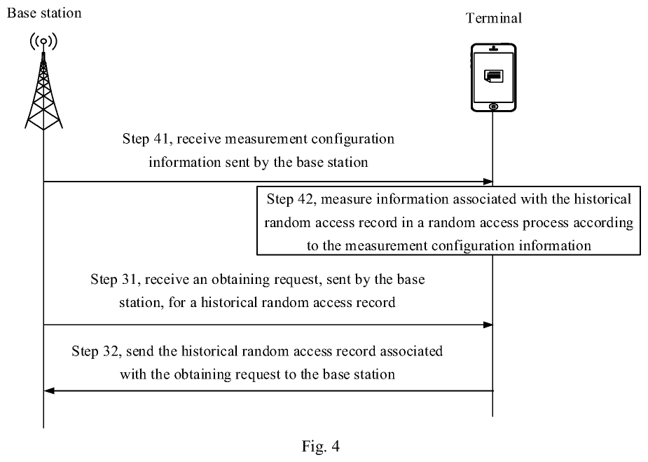

As shown in FIG. 4, an example provides a method for determining a random access configuration of a terminal. The method further includes:

Step 41, receive measurement configuration information sent by the base station.

In an example, the measurement configuration information includes the information contained in the historical random access record.

In an example, the measurement configuration information may include the following information to be measured:

information about a four-step random access type selected by the terminal;

information about a two-step random access type selected by the terminal;

information about reference signal receiving power (RSRP) of a downlink loss reference during random access;

information about a reference signal receiving power (RSRP) threshold of the downlink loss reference of a random access type selected during random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

Step 42, measure information associated with the historical random access record in a random access process according to the measurement configuration information.

In an example, the measurement configuration information includes: information about the reference signal receiving power (RSRP) of a downlink loss reference during random access; information about a reference signal receiving power (RSRP) threshold of the downlink loss reference of a random access type selected during random access; and information about the number of times of random access performed by the terminal under different random access types. Further, during random access, the terminal measures information about the reference signal receiving power (RSRP) of the downlink loss reference, information about the reference signal receiving power (RSRP) threshold of the downlink loss reference of a selected random access type, and information about the number of times of random access performed by the terminal under different random access types.

In an example, the historical random access record is at least configured to determine the configuration of a reference signal receiving power (RSRP) threshold of a downlink loss reference associated with at least one random access type for the one or more terminals based on the information about the number of times of random access performed by the terminal under different random access types and/or the information about random access results of random access performed by the terminal under different random access types.

In an example, the base station determines the configuration of a reference signal receiving power (RSRP) threshold of a downlink loss reference associated with at least one random access type for the one or more terminals based on the information about the number of times of random access performed by one or more terminals under different random access types.

In an example, the base station determines the configuration of a reference signal receiving power (RSRP) threshold of a downlink loss reference associated with at least one random access type for the one or more terminals based on the information about random access results of random access performed by one or more terminals under different random access types.

In an example, the base station determines the configuration of a reference signal receiving power (RSRP) threshold of a downlink loss reference associated with at least one random access type for the one or more terminals based on the information about the number of times of random access performed by one or more terminals under different random access types and the information about random access results of random access performed by one or more terminals under different random access types.

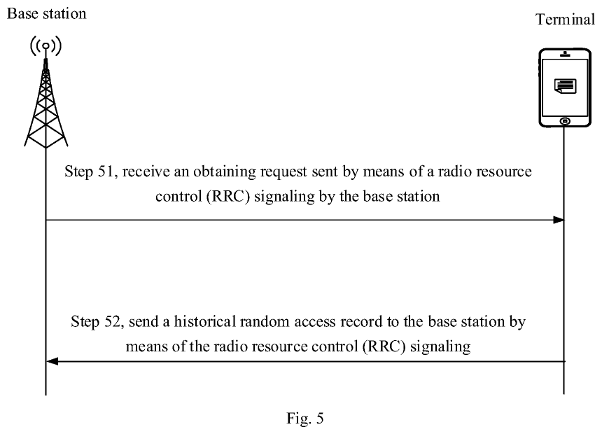

As shown in FIG. 5, an example provides a method for determining a random access configuration of a terminal. Step 31 of receiving an obtaining request, sent by a base station, for a historical random access record includes:

Step 51, receive the obtaining request sent by means of a radio resource control (RRC) signaling by the base station.

In an example, the obtaining request for the historical random access record may be sent by the base station to the terminal when the terminal is in a radio resource control (RRC) connection state.

In an example, the obtaining request may contain period-of-time information that needs to be obtained and corresponds to sending of the historical random access record. The period-of-time information is used for instructing the terminal to report a historical random access record within the period of time. For instance, the period-of-time information is used for instructing the terminal to report a historical random access record within the past 24 hours.

In an example, the obtaining request may instruct the terminal to report a historical random access record for a period of time from attempting random access until succeeding in random access.

In an example, the obtaining request contains an instruction that one or more historical random access records need to be obtained. For instance, the obtaining request instructs the terminal to report one or more pieces of the following information of the historical random access record:

information about a four-step random access type selected by the terminal;

information about a two-step random access type selected by the terminal;

information about reference signal receiving power (RSRP) of a downlink loss reference during random access;

information about a reference signal receiving power (RSRP) threshold of the downlink loss reference of a random access type selected during random access;

information about the number of times of random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the radio resource control (RRC) signaling may be radio resource control (RRC) connection reconfiguration signaling including the obtaining request carrying the historical random access record. The base station sends the obtaining request for the historical random access record to the terminal by means of a radio resource control (RRC) connection reconfiguration signaling. In this way, the existing radio resource control (RRC) signaling may be used for carrying the obtaining request for the historical random access record, so as to implement multiplexing of the radio resource control (RRC) signaling, and improve compatibility of the signaling.

Step 32 of sending the historical random access record associated with the obtaining request to the base station includes:

Step 52, send the historical random access record to the base station by means of the radio resource control (RRC) signaling.

In an example, the terminal sends a historical random access record for a certain period of time based on the obtaining request. The obtaining request indicates the period of time. For instance, the obtaining request instructs the terminal to report a historical random access record within the past 24 hours. The terminal then reports the historical random access record within the past 24 hours to the base station.

In an example, based on the obtaining request, the terminal sends a historical random access record for a period of time from attempting random access until succeeding in random access by the terminal.

In an example, the historical random access record reported by the terminal is determined according to the instruction of the obtaining request. For instance, according to the instruction of the obtaining request, one or more pieces of the following information contained in the historical random access record are reported:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the radio resource control (RRC) signaling is user equipment assistance information (UE assistance information). In an application scene, a base station receives user equipment assistance information (UE assistance information) sent by a terminal and carries a historical random access record.

In this way, in the example, the existing radio resource control (RRC) signaling may be used for carrying the historical random access record, so as to implement multiplexing of the radio resource control (RRC) signaling, and improve the compatibility of the signaling.

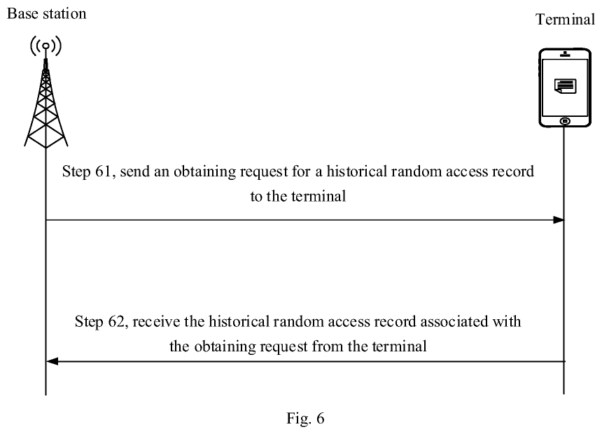

As shown in FIG. 6, an example provides a method for determining a random access configuration of a terminal. The method is applied to a base station and includes:

Step 61, send an obtaining request for a historical random access record to the terminal.

In an example, the terminal may be, but is not limited to, a mobile phone, a wearable device, a vehicle-mounted terminal, a road side unit (RSU), a smart home terminal, an industrial sensing device and/or a medical device, etc.

In an example, the base station is an interface device for the terminal to access a network. The base station may be various types of base stations, for instance, a 3G base station, a 4G base station, a 5G base station, or another evolved base station.

In an example, the random access types of the terminal include a two-step random access type and a four-step random access type. An access time delay of the two-step random access is less than that of the four-step random access. An access rate of the two-step random access is greater than that of the four-step random access.

In an example, when a service of the terminal is a low-latency and/or high-rate service, the base station may configure the terminal to access a channel by means of two-step random access so as to send data to the base station.

In an example, the low-latency and/or high-rate service may be a service of ultra-high definition video, video conferencing, 3D gaming, etc. in an enhanced mobile broadband scene.

In another example, the low-latency and/or high-rate service may further be a service of Internet-of-Vehicles, industrial control, telemedicine, etc. in a low-latency and high-reliability scene.

In an example, the base station may configure the terminal to support the two-step random access type and/or configure the terminal to support the four-step random access type.

In an example, when the terminal supports both the two-step random access type and the four-step random access type, the two-step random access type may be preferentially used for random access.

In an example, the obtaining request for the historical random access record is sent by the base station to the terminal when the terminal is in a radio resource control (RRC) connection state.

In an example, information contained in the historical random access record includes one or more of the following:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times s random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the historical random access record may be recorded according to time. For instance, at time point A, the terminal attempts to access a base station with an identity document X1 by means of four-step random access, and the terminal records the following information: time information about time point A; information that the terminal selects the four-step random access type for random access; information that measured reference signal receiving power (RSRP) of a downlink loss reference is a value a; information that a reference signal receiving power (RSRP) threshold of the downlink loss reference selected by the currently set random access type is value b; information about a result of current successful random access; information that the identity document (ID) of the accessed base station is X1; information that the random access preamble selected for current random access is preamble Q1; and information the random access resource selected by the current random access is resource Z1. Different random access types use different preambles. The random access resource is a time-frequency domain resource used during random access. The identity document (ID) of the base station is configured to uniquely identify one base station.

In an example, the historical random access record may further be recorded according to the number of times of random access. For instance, when the terminal attempts to access a base station with an identity document X1 by means of two-step random access for the tenth time, the terminal records the following information: information that the terminal selects the two-step random access type for random access for the tenth time; information that measured reference signal receiving power (RSRP) of a downlink loss reference is a value a; information that a reference signal receiving power (RSRP) threshold of the downlink loss reference selected by the currently set random access type is value b; information about a result of current failed random access; information that the identity document (ID) of the accessed base station is X2; information that the random access preamble selected for current random access is preamble Q2; and information the random access resource selected by the current random access is resource Z2. Different random access types use different preambles. The random access resource is a time-frequency domain resource used during random access. The identity document (ID) of the base station is configured to uniquely identify one base station.

In an example, the reference signal receiving power (RSRP) of the downlink loss reference during random access may be receiving the power of a reference signal measured by the terminal. The reference signal receiving power (RSRP) of the downlink loss reference may be an average of the reference signal received power (RSRP) of the downlink loss reference measured a plurality of times.

In an example, different random access types correspond to different reference signal receiving power (RSRP) thresholds of the downlink loss reference.

In an example, a reference signal receiving power (RSRP) threshold of a downlink loss reference corresponding to a two-step random access type is greater than a reference signal receiving power threshold corresponding to a four-step random access type. In this way, since a condition of the reference signal receiving power (RSRP) threshold of the downlink loss reference corresponding to the four-step random access type may be satisfied more easily, the terminal may preferentially use the four-step random access type for random access.

In an example, a reference signal receiving power (RSRP) threshold of a downlink loss reference is a first threshold. When a measured reference signal receiving power (RSRP) of the downlink loss reference is greater than the first threshold, a two-step random access type is used for random access. When the measured reference signal receiving power (RSRP) of the downlink loss reference is less than the first threshold, a four-step random access type is used for random access.

In another example, a reference signal receiving power (RSRP) threshold of a downlink loss reference includes a second threshold and a third threshold. The second threshold is a threshold for random access using a two-step random access type, and the third threshold is a threshold for random access using a four-step random access type, the second threshold being greater than the third threshold. In an example, when a measured reference signal receiving power (RSRP) of a downlink loss reference is less than the second threshold and greater than the third threshold, a four-step random access type is used for random access. When the measured reference signal receiving power (RSRP) of the downlink loss reference is greater than the second threshold, a two-step random access type is used for random access.

In an example, the terminal accumulatively counts the number of times of random access using the two-step random access type and the number of times of random access using the four-step random access type. For instance, in a preset period of time, the number of times of random accesses using the two-step random access type is ten, and the number of times of random accesses using the four-step random access type is fifteen.

In an example, a period of accumulatively counting may be a preset time, for instance, 24 hours.

In an example, a period of accumulatively counting may be from a point in time when the terminal attempts random access to a point in time when the terminal attempts random access successfully.

In an example, in a period of accumulative counting being 24 hours, the number of times of random access using the two-step random access type by the terminal is ten, where five times of random access fail. The number of times of random access using the four-step random access type by the terminal is fifteen, where six times of random access fail.

Step 62, receive the historical random access record associated with the obtaining request from the terminal.

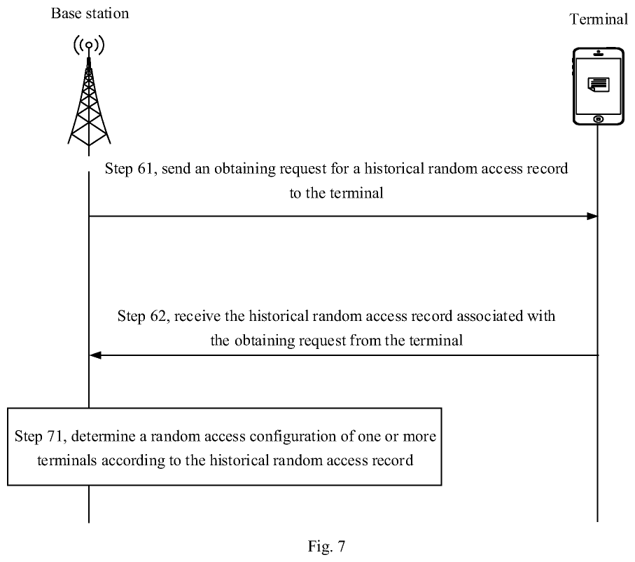

As shown in FIG. 7, an example provides a method for determining a random access configuration of a terminal. The method further includes:

Step 71, determine a random access configuration of one or more terminals according to the historical random access record.

In an example, the historical random access record is used at least for the base station to determine a random access configuration of one or more terminals.

In an example, a random access configuration may configure a reference signal receiving power (RSRP) threshold of a downlink loss reference when the terminal uses a two-step random access type or a four-step random access type for random access.

In an example, when a measured reference signal receiving the power of a downlink loss reference is greater than a reference signal receiving the power threshold of a downlink loss reference corresponding to a random access type used by the terminal, the terminal may use the random access type for random access. For instance, when the terminal uses a two-step random access type for random access, a reference signal receiving the power threshold of a downlink loss reference is a, a currently measured reference signal receiving the power of the downlink loss reference is b, and if b>a, the terminal may use the two-step random access type for random access.

In an example, when a terminal is required to have a high random access success rate, a reference signal receiving the power threshold of a downlink loss reference may be configured as A. When the terminal is required to have a relatively low random access success rate, the reference signal receiving power of the downlink loss reference may be configured as B. A is greater than B.

A random access configuration of one or more terminals is determined according to the historical random access record of the one or more terminals.

In an example, a random access configuration of a terminal is determined according to a historical random access record of the terminal. For instance, a random access configuration of a terminal A is determined according to a historical random access record of the terminal A.

A random access condition of a position where the terminal A is located may be known according to the historical random access record of the terminal A, so as to determine the random access configuration of the terminal according to the historical random access record of the terminal A, and better adapt to the random access condition of the position where the terminal A is located. Compared with the terminal A using a fixed random access configuration for random access, a higher success rate and better stability of random access may be achieved. In this way, a success rate of random access of each terminal is improved, and the stability of random access of each terminal is improved.

In an example, random access configurations of a plurality of terminals are determined according to a historical random access record of one terminal. For instance, according to the historical random access record of the terminal A, the random access configurations of terminals B, C and D located within the same range as the terminal A are determined. The random access configurations of A, B, C, and D are identical. The same range may be a cell.

A random access condition of a position where the terminal A is located may be known according to the historical random access record of the terminal A, so as to determine the random access configurations of the terminal A and the terminals B, C and D located within the same range as the terminal A according to the historical random access record of the terminal A. Since the terminals B, C and D are located within the same range as the terminal A, the random access conditions are similar to that of the terminal A, and the random access condition of the position where the terminal A is located may provide a reference for the terminals B, C and D. The random access configuration of the terminals B, C and D determined according to the historical random access record of the terminal A may better adapt to the random access conditions of the positions where the terminals B, C and D are located. Compared with the terminals B, C and D using a fixed random access configuration for random access, a higher success rate and better stability of random access may be achieved. Moreover, the base station does not need to obtain a historical random access record of each terminal, so as to reduce data interaction and save system resources. In an example, a random access configuration of one terminal is determined according to historical random access records of a plurality of terminals. For instance, a random access configuration of a terminal A is determined according to historical random access records of terminals A, B, C and D. The terminals B, C and D are located in the same range as the terminal A. The same range may be a cell.

Random access conditions of positions where the terminals B, C and D are located may be known according to the historical random access records of the terminals B, C and D, so as to determine the random access configuration of the terminal A located within the same range as the terminals B, C and D according to the historical random access records of the terminals B, C and D. Since the terminals B, C and D are located within the same range as the terminal A, the random access conditions are similar to that of the terminal A, and the random access conditions of the positions where the terminals B, C and D are located may provide a reference for the terminal A to determine the random access configuration. The random access configuration of the terminal A determined according to the historical random access records of the terminals B, C and D may better adapt to the random access condition of the position where the terminal A is located. Compared with the terminals B, C and D using fixed random access configurations for random access, a higher success rate and better stability of random access may be achieved. Moreover, it is more accurate to determine the random access configuration of the terminal A based on the historical random access records of a plurality of terminals within the same range as the terminal A. In an example, random access configurations of a plurality of terminals are determined according to historical random access records of the plurality of terminals. For instance, random access configurations of terminals A, B, C, and D are determined according to historical random access records of the terminals A, B, C, and D. The random access configurations of A, B, C, and D are identical. The terminals A, B, C, and D may be located within the same range. The same range may be a cell.

Random access conditions of positions where the terminals A, B, C, and D are located may be known according to the historical random access records of the terminals A, B, C, and D, so as to determine the random access configurations of the terminals A, B, C, and D according to the historical random access records of the terminals A, B, C, and D. Compared with the terminals B, C, and D using fixed random access configurations for random access, a higher success rate and better stability of random access may be achieved.

In an example, the random access configuration includes one or more of the following: a configuration of a random access type selected by the terminal; and a configuration of a reference signal receiving power (RSRP) threshold of a downlink loss reference associated with random access.

In an example, the base station instructs the terminal to use a two-step random access type for random access. However, in the past 24 hours, during ten two-step random access attempts by the terminal, eight times a random access fails, and in this case, the base station may adjust the two-step random access type for random access to the four-step random access type for random access for the terminal.

In an example, a reference signal receiving power (RSRP) threshold of the downlink loss reference is c when the base station instructs the terminal to use the two-step random access type for random access. However, in the past 24 hours, during ten random access attempts by the terminal, eight times of random access fails. In this case, the base station may raise the reference signal receiving power (RSRP) threshold of the downlink loss reference from c to d, and c<d. The reference signal receiving power (RSRP) threshold d of the downlink loss reference is raised, such that reference signal strength must be greater than the higher reference signal receiving power (RSRP) threshold of the downlink loss reference in order to attempt to use the two-step random access type for random access, which may limit the number of times that the terminal attempts to use the two-step random access type for random access. The success rate of random access is improved.

In an example, the random access configuration includes one or more of the following: a configuration of a random access type selected by the terminal; and a configuration of a reference signal receiving power (RSRP) threshold of a downlink loss reference associated with random access.

In an example, the base station instructs the terminal to use a two-step random access type for random access. However, in the past 24 hours, during ten random access attempts by the terminal, eight times of random access fails, and in this case, the base station may adjust the two-step random access type for random access to the four-step random access type for random access for the terminal.

In an example, a reference signal receiving power (RSRP) threshold of the downlink loss reference is c when the base station instructs the terminal to use the two-step random access type for random access. However, in the past 24 hours, during ten random access attempts by the terminal, eight times of random access fails. In this case, the base station may raise the reference signal receiving power (RSRP) threshold of the downlink loss reference from c to d, and c<d. The reference signal receiving power (RSRP) threshold of the downlink loss reference is raised, such that reference signal strength must be greater than the higher reference signal receiving power (RSRP) threshold of the downlink loss reference in order to attempt to use the two-step random access type for random access, which may limit the number of times that the terminal attempts to use the two-step random access type for random access. The success rate of random access is improved.

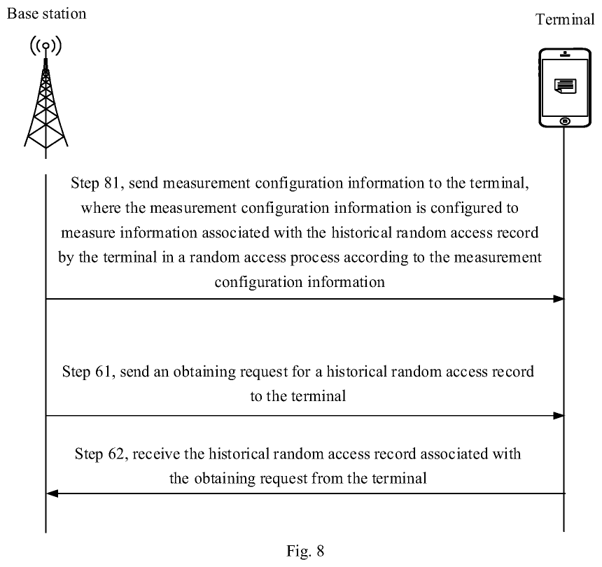

As shown in FIG. 8, an example provides a method for determining a random access configuration of a terminal. The method further includes:

Step 81, send measurement configuration information to the terminal, where the measurement configuration information is configured to measure information associated with the historical random access record by the terminal in a random access process according to the measurement configuration information.

In an example, the measurement configuration information includes the information contained in the historical random access record.

In an example, the measurement configuration information includes one or more of history records of the random access information:

information about a four-step random access type selected by the terminal;

information about a two-step random access type selected by the terminal;

information about reference signal receiving power (RSRP) of a downlink loss reference during random access;

information about a reference signal receiving power (RSRP) threshold of the downlink loss reference of a random access type selected during random access;

information about the number of times of random access performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the measurement configuration information includes: information about the reference signal receiving power (RSRP) of a downlink loss reference during random access; information about a reference signal receiving power (RSRP) threshold of the downlink loss reference of a random access type selected during random access; and information about the number of times of random access performed by the terminal under different random access types. Further, during random access, the terminal measures information about the reference signal receiving power (RSRP) of the downlink loss reference, information about the reference signal receiving power (RSRP) threshold of the downlink loss reference of a selected random access type, and information about the number of times of random access performed by the terminal under different random access types.

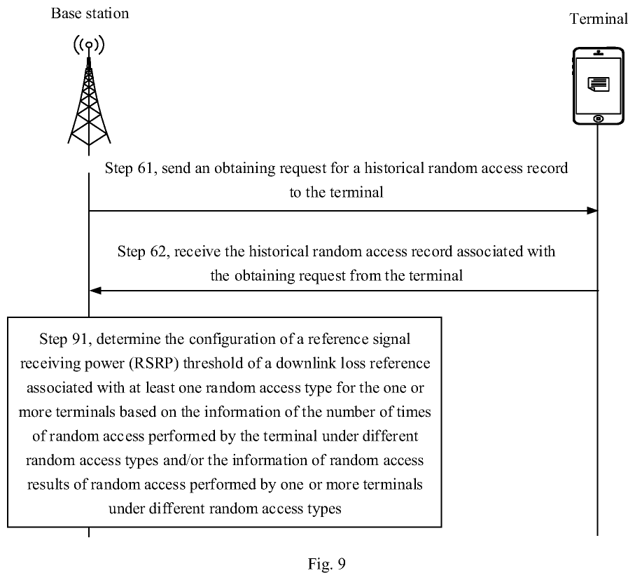

As shown in FIG. 9, an example provides a method for determining a random access configuration of a terminal. Step 71 of determining a random access configuration of one or more terminals according to the historical random access record includes:

Step 91, determine the configuration of a reference signal receiving power (RSRP) threshold of a downlink loss reference associated with at least one random access type for the one or more terminals based on the information about the number of times of random access performed by the terminal under different random access types and/or the information about random access results of random access performed by one or more terminals under different random access types.

In an example, the base station determines the configuration of a reference signal receiving power (RSRP) threshold of a downlink loss reference associated with at least one random access type for the one or more terminals based on the information about the number of times of random access performed by one or more terminals under different random access types.

In an example, the base station determines the configuration of a reference signal receiving power (RSRP) threshold of a downlink loss reference associated with at least one random access type for the one or more terminals based on the information about random access results of random access performed by one or more terminals under different random access types.

In an example, the base station determines the configuration of a reference signal receiving power (RSRP) threshold of a downlink loss reference associated with at least one random access type for the one or more terminals based on the information about the number of times of random access performed by one or more terminals under different random access types and the information about random access results of random access performed by one or more terminals under different random access types.

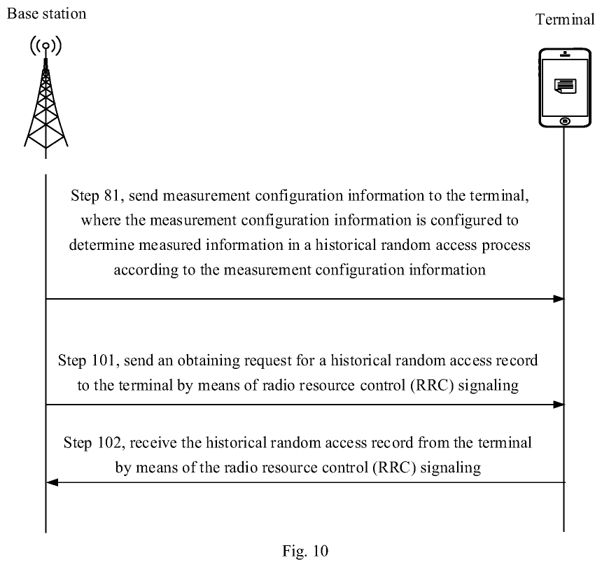

As shown in FIG. 10, an example provides a method for determining a random access configuration of a terminal. Step 61 of sending an obtaining request for a historical random access record to the terminal includes:

Step 101, sends the obtaining request for the historical random access record to the terminal by means of a radio resource control (RRC) signaling.

In an example, the obtaining request for the historical random access record may be sent by the base station to the terminal when the terminal is in a radio resource control (RRC) connection state.

In an example, the obtaining request may contain period-of-time information that needs to be obtained and corresponds to sending of the historical random access record. The period-of-time information is used for instructing the terminal to report a historical random access record within the period of time. For instance, the period-of-time information is used for instructing the terminal to report a historical random access record within the past 24 hours.

In an example, the obtaining request may instruct the terminal to report a historical random access record for a period of time from attempting random access until succeeding in random access.

In an example, the obtaining request contains an instruction that one or more historical random access records need to be obtained. For instance, the obtaining request instructs the terminal to report one or more pieces of the following information of the historical random access record:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types. In an example, the radio resource control (RRC) signaling may be radio resource control (RRC) connection reconfiguration signaling including the obtaining request carrying the historical random access record. The base station sends the obtaining request for the historical random access record to the terminal by means of a radio resource control (RRC) connection reconfiguration signaling. In this way, the existing radio resource control (RRC) signaling may be used for carrying the obtaining request for the historical random access record, so as to implement multiplexing of the radio resource control (RRC) signaling, and improve the compatibility of the signaling.

Step 62 of receiving the historical random access record associated with the obtaining request from the terminal includes:

Step 102, receive the historical random access record from the terminal by means of the RRC signaling.

In an example, the terminal sends a historical random access record for a certain period of time based on the obtaining request. The obtaining request indicates the period of time. For instance, the obtaining request instructs the terminal to report a historical random access record within the past 24 hours. The terminal then reports the historical random access record within the past 24 hours to the base station.

In an example, based on the obtaining request, the terminal sends a historical random access record for a period of time from attempting random access until succeeding in random access by the terminal.

In an example, the historical random access record reported by the terminal is determined according to the instruction of the obtaining request. For instance, according to the instruction of the obtaining request, one or more of the following historical random access records are reported:

information about a four-step random access type selected by the terminal;

information about a two-step random access type selected by the terminal;

information about reference signal receiving power (RSRP) of a downlink loss reference during random access;

information about a reference signal receiving power (RSRP) threshold of the downlink loss reference of a random access type selected during random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the radio resource control (RRC) signaling is user equipment assistance information (UE assistance information). In an application scene, a base station receives user equipment assistance information (UE assistance information) sent by a terminal and carrying a historical random access record.

In this way, in the example, the existing radio resource control (RRC) signaling may be used for carrying the historical random access record, so as to implement multiplexing of the radio resource control (RRC) signaling, and improve compatibility of the signaling.

As shown in FIG. 11, an example provides an apparatus for determining a random access configuration of a terminal. The apparatus is applied to the terminal and includes a first reception module 111 and a first sending module 112, where

the first reception module 111 is configured to receive an obtaining request, sent by a base station, for a historical random access record; and

the first sending module 112 is configured to send the historical random access record associated with the obtaining request to the base station.

In an example, the first sending module 112 is further configured in such a way that the historical random access record is used at least for the base station to determine a random access configuration of one or more terminals.

In an example, the apparatus further includes a measurement module 113, where

the first reception module 111 is further configured to receive measurement configuration information sent by the base station; and

the measurement module 113 is further configured to measure information associated with the historical random access record in a random access process according to the measurement configuration information.

In an example, the first sending module 112 is further configured in such a way that information contained in the historical random access record includes one or more of the following:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the first sending module 112 is further configured in such a way that the random access configuration includes one or more of the following:

a configuration of a random access type selected by the terminal; and

a configuration of a reference signal receiving power (RSRP) threshold of a downlink loss reference associated with random access.

In an example, the first sending module 112 is further configured in such a way that the historical random access record is at least configured to determine the configuration of a reference signal receiving power (RSRP) threshold of a downlink loss reference associated with at least one random access type for the one or more terminals based on the information about the number of times of random access performed by the terminal under different random access types and/or the information about random access results of random access performed by the terminal under different random access types.

In an example, the first reception module 111 is further configured to receive the obtaining request sent by means of a radio resource control (RRC) signaling by the base station; and

the first sending module 112 is further configured to send the historical random access record to the base station by means of the radio resource control (RRC) signaling.

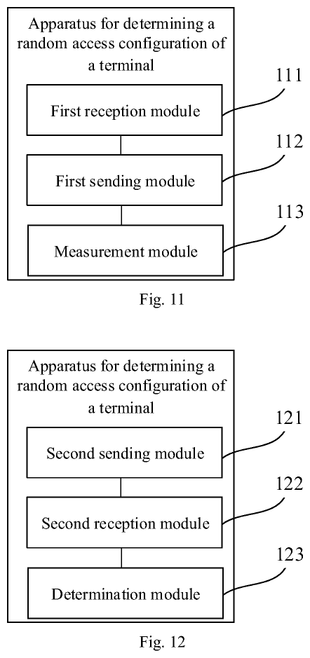

As shown in FIG. 12, an example provides an apparatus for determining a random access configuration of a terminal. The apparatus is applied to a base station and includes a second sending module 121 and a second reception module 122, where

the second sending module 121 is configured to send an obtaining request for a historical random access record to the terminal; and

the second reception module 122 is configured to receive the historical random access record associated with the obtaining request from the terminal.

In an example, the apparatus further includes a determination module 123, where the determination module 123 is further configured to determine a random access configuration of one or more terminals according to the historical random access record.

In an example, the second sending module 121 is further configured to send measurement configuration information to the terminal, and the measurement configuration information is configured to measure information associated with the historical random access record by the terminal in a historical random access process according to the measurement configuration information.

In an example, the second reception module 122 is further configured in such a way that information contained in the historical random access record includes one or more of the following:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the second reception module 122 is further configured in such a way that the random access configuration includes one or more of the following:

a configuration of a random access type selected by the terminal; and

a configuration of a reference signal receiving power (RSRP) threshold of a downlink loss reference associated with random access.

In an example, the determination module 123 is further configured to determine the configuration of a reference signal receiving power (RSRP) threshold of a downlink loss reference associated with at least one random access type for the one or more terminals based on the information about the number of times of random access performed by the terminal under different random access types and/or the information about random access results of random access performed by one or more terminals under different random access types.

In an example, the second sending module 121 is further configured to send the obtaining request for the historical random access record to the terminal by means of a radio resource control (RRC) signaling; and

the second reception module 122 is further configured to receive the historical random access record from the terminal by means of the radio resource control (RRC) signaling.

With respect to the apparatus in the above examples, specific ways in which the various modules execute operations have been described in detail in the examples relating to the method, and will not be described in detail here.

An example of the disclosure provides a communication device. The communication device includes:

a processor; and

a memory configured to store an instruction executable by the processor;

where the processor is configured to implement the method used for any one of examples of the disclosure when running the executable instruction.

The processor may include various types of storage media that are non-transitory computer storage media capable of continuing to remember the information stored after the communication device is powered down.

The processor may be connected to the memory by means of a bus, etc. for reading an executable program stored in the memory.

The example of the disclosure further provides a computer storage medium. The computer storage medium stores a computer-executable program, and when executed by a processor, the executable program implements the method according to any one of examples of the disclosure.

With respect to the apparatus in the above examples, specific ways in which the various modules execute operations have been described in detail in the examples relating to the method, and will not be described in detail here.

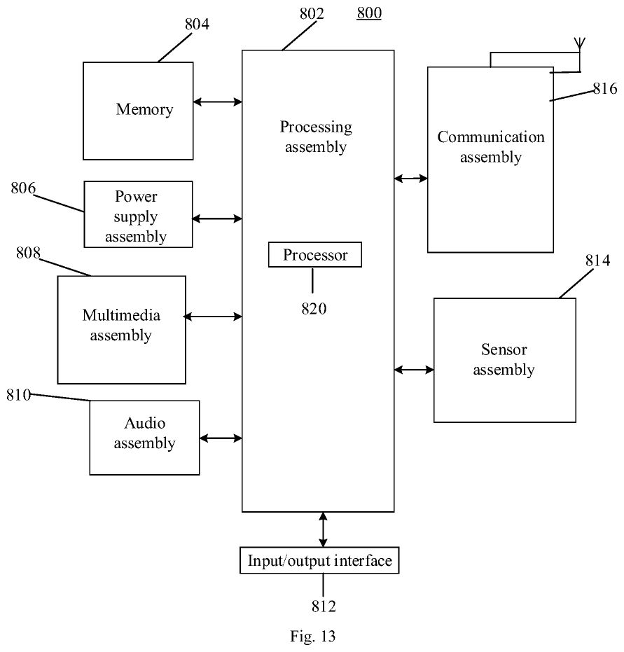

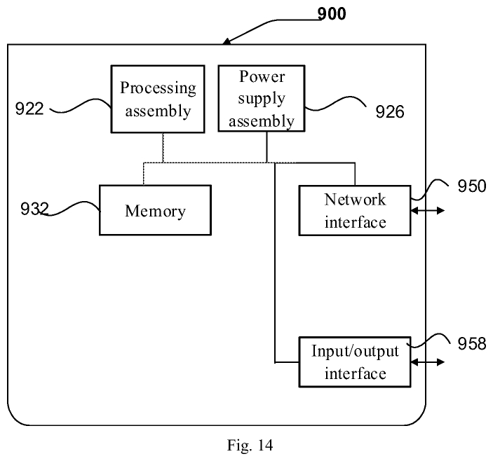

FIG. 13 is a block diagram of user equipment (UE) 800 according to an example. For instance, the user equipment 800 may be a mobile phone, a computer, digital broadcast user equipment, a messaging device, a gaming console, a tablet device, a medical device, a fitness device, a personal digital assistant, etc.

With reference to FIG. 13, the user equipment 800 may include one or more of a processing assembly 802, a memory 804, a power supply assembly 806, a multimedia assembly 808, an audio assembly 810, an input/output (I/O) interface 812, a sensor assembly 814, and a communication assembly 816.

The processing assembly 802 generally controls the overall operation of the user equipment 800, for instance, operations associated with display, phone calls, data communications, camera operations, and recording operations. The processing assembly 802 may include one or more processors 820 to execute an instruction to complete all or part of the steps of the method above. Moreover, the processing assembly 802 may include one or more modules to facilitate interaction between the processing assembly 802 and other assemblies. For instance, the processing assembly 802 may include the multimedia module to facilitate interaction between the multimedia assembly 808 and the processing assembly 802.

The memory 804 is configured to store various types of data to support operation on the user equipment 800. Instances of such data include an instruction, operated on the user equipment 800, for any application or method, contact data, phonebook data, messages, pictures, video, etc. The memory 804 may be implemented by any type of volatile or non-volatile memory apparatus, or their combination, for instance, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply assembly 806 supplies power to the various assemblies of the user equipment 800. The power supply assembly 806 may include a power management system, one or more power supplies, and other assemblies associated with power generation, management, and distribution for the user equipment 800.

The multimedia assembly 808 includes a screen that provides an output interface between the user equipment 800 and the user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touches, slides, and gestures on the touch panel. The touch sensor may not only sense a boundary of a touch or slide action, but also detect duration and pressure related to the touch or slide operation. In some examples, the multimedia assembly 808 includes a front-facing camera and/or a rear-facing camera. When the user equipment 800 is in an operational mode, for instance, a photographing mode or a video mode, the front-facing camera and/or the rear-facing camera may receive external multimedia data. Each of the front-facing camera and the rear-facing camera may be a fixed optical lens system or have a focal length and optical zoom capability.

The audio assembly 810 is configured to output and/or input an audio signal. For instance, the audio assembly 810 includes a microphone (MIC) configured to receive an external audio signal when the user equipment 800 is in the operational mode, for instance, a calling mode, a recording mode, and a speech recognition mode. The received audio signal may be further stored in the memory 804 or sent via the communication assembly 816. In some examples, the audio assembly 810 further includes a speaker for outputting the audio signal.

The I/O interface 812 provides an interface between the processing assembly 802 and a peripheral interface module. The peripheral interface module may be a keyboard, a click wheel, a button, etc. These buttons may include, but are not limited to, a home button, a volume button, a start button, and a lock button.

The sensor assembly 814 includes one or more sensors for providing state assessments of various aspects of the user equipment 800. For instance, the sensor assembly 814 may detect an on/off state of the user equipment 800 and the relative positioning of the assemblies. For instance, the assemblies are a display and a keypad of the user equipment 800. The sensor assembly 814 may also detect a change in position of the user equipment 800 or an assembly of the user equipment 800, the presence or absence of contact between the user and the user equipment 800, orientation or acceleration/deceleration of the user equipment 800, and temperature variation of the user equipment 800. The sensor assembly 814 may include a proximity sensor configured to detect the presence of nearby objects in the absence of any physical contact. The sensor assembly 814 may also include a light sensor, for instance, a complementary metal oxide semiconductor (CMOS) or charge coupled device (CCD) image sensor, for use in imaging applications. In some examples, the sensor assembly 814 may also include an acceleration sensor, a gyroscopic sensor, a magnetic sensor, a pressure sensor, or a temperature sensor.

The communication assembly 816 is configured to facilitate communications between the user equipment 800 and other devices in a wired or wireless mode. The user equipment 800 may access a wireless network based on a communication standard, for instance, WiFi, 2G, or 3G, or their combination. In an example, the communication assembly 816 receives a broadcast signal or broadcast related information from an external broadcast management system via a broadcast channel. In an example, the communication assembly 816 also includes a near field communication (NFC) module to facilitate short-range communication. For instance, the NFC module may be implemented based on a radio frequency identification (RFID) technology, an infrared data association (IrDA) technology, an ultra wide band (UWB) technology, a Bluetooth (BT) technology, and other technologies.

In an example, the user equipment 800 may be implemented by one or more application specific integrated circuits (ASIC), a digital signal processor (DSP), a digital signal processing device (DSPD), a programmable logic device (PLD), a field programmable gate array (FPGA), a controller, a microcontroller, a microprocessor, or other electronic elements for executing the method above.

In an example, further provided is a non-transitory computer-readable storage medium including an instruction, for instance, a memory 804 including an instruction, and the instruction may be executed by the processor 820 of the user equipment 800 so as to execute the method above. For instance, the non-transitory computer-readable storage medium may be a read-only memory (ROM), a random access memory (RAM), a compact disc read-only memory (CD-ROM), a magnetic tape, a floppy disk, an optical data storage apparatus, etc.

As shown in FIG. 14, an example of the disclosure shows a structure of a base station. For instance, the base station 900 may be provided as a network side device. With reference to FIG. 13, the base station 900 includes a processing assembly 922, and further includes one or more processors, and memory resources represented by a memory 932 for storing an instruction executable by the processing assembly 922, for instance, an application program. The application program stored in the memory 932 may include one or more modules, each of which corresponds to a set of instructions. Further, the processing assembly 922 is configured to execute the instructions to implement any of the methods described above as used for the base station.

The base station 900 may further include a power supply assembly 926 configured to implement power supply management of the base station 900, a wired or radio network interface 950 configured to connect the base station 900 to a network, and an input/output (I/O) interface 958. The base station 900 may operate an operating system stored in the memory 932, for instance, Windows Server™, Mac OS X™, Unix™, Linux™, FreeBSD™, etc.

Those skilled in the art can readily conceive of other examples of the disclosure upon consideration of the specification and practice of the disclosure. The disclosure is intended to cover any variations, uses, or adaptive changes of the disclosure, and these variations, uses, or adaptive changes follow general principles of the disclosure and include common general knowledge or customary technical means in the technical field not disclosed in the disclosure. The specification and examples are considered as illustrative merely, and the true scope and spirit of the disclosure are indicated by the following claims.

It is to be understood that the disclosure is not limited to the precise structure that has been described above and shown in the accompanying drawings and can be modified and altered in various ways without departing from its scope. The scope of the disclosure is limited only by the appended claims.

Disclosed in the examples of the disclosure are a method and apparatus for determining a random access configuration of a terminal, a communication device and a storage medium.

According to a first aspect of examples of the disclosure, provided is a method for determining a random access configuration of a terminal. The method is applied to the terminal and includes:

receiving an obtaining request, sent by a base station, for a historical random access record; and sending the historical random access record associated with the obtaining request to the base station.

In an example, the historical random access record is used at least for the base station to determine a random access configuration of one or more terminals.

In one example, the method further includes:

receiving measurement configuration information sent by the base station; and

measuring information associated with the historical random access record in a random access process according to the measurement configuration information.

In an example, the information contained in the historical random access record includes one or more of the following:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the random access configuration includes one or more of the following:

a configuration of a random access type selected by the terminal; and

a configuration of a reference signal receiving power (RSRP) threshold of a downlink loss reference associated with random access.

In an example, the historical random access record is at least configured to determine the configuration of a reference signal receiving power (RSRP) threshold of a downlink loss reference associated with at least one random access type for the one or more terminals based on the information about the number of times of random access performed by the terminal under different random access types and/or the information about random access results of random access performed by the terminal under different random access types.

In an example, the receiving an obtaining request, sent by a base station, for a historical random access record includes:

receiving the obtaining request sent by means of a radio resource control (RRC) signaling by the base station; and

the sending the historical random access record associated with the obtaining request to the base station includes:

sending the historical random access record to the base station by means of the radio resource control (RRC) signaling.

According to a second aspect of examples of the disclosure, provided is a method for determining a random access configuration of a terminal. The method is applied to a base station and includes:

sending an obtaining request for a historical random access record to the terminal; and

receiving the historical random access record associated with the obtaining request from the terminal.

In one example, the method further includes:

determining a random access configuration of one or more terminals according to the historical random access record.

In one example, the method further includes:

sending measurement configuration information to the terminal, where the measurement configuration information is configured to measure information associated with the historical random access record by the terminal in a random access process according to the measurement configuration information.

In an example, information contained in the historical random access record includes one or more of the following:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the random access configuration includes one or more of the following:

a configuration of a random access type selected by the terminal; and

a configuration of a reference signal receiving power (RSRP) threshold of a downlink loss reference associated with random access.

In an example, the determining a random access configuration of one or more terminals according to the historical random access record includes:

determining the configuration of a reference signal receiving power (RSRP) threshold of a downlink loss reference associated with at least one random access type for the one or more terminals based on the information about the number of times of random access performed by the terminal under different random access types and/or the information about random access results of random access performed by one or more terminals under different random access types.

In an example, the sending an obtaining request for a historical random access record to the terminal includes:

sending the obtaining request for the historical random access record to the terminal by means of a radio resource control (RRC) signaling; and

the receiving the historical random access record associated with the obtaining request from the terminal includes:

receiving the historical random access record from the terminal by means of the radio resource control (RRC) signaling.

According to a third aspect of examples of the disclosure, provided is an apparatus for determining a random access configuration of a terminal. The apparatus is applied to the terminal and includes a first reception module and a first sending module, where

the first reception module is configured to receive an obtaining request, sent by a base station, for a historical random access record; and

the first sending module is configured to send the historical random access record associated with the obtaining request to the base station.

In an example, the first sending module is further configured in such a way that the historical random access record is used at least for the base station to determine a random access configuration of one or more terminals.

In an example, the apparatus further includes a measurement module, where

the first reception module is further configured to receive measurement configuration information sent by the base station; and

the measurement module is further configured to measure information associated with the historical random access record in a random access process according to the measurement configuration information.

In an example, the first sending module is further configured in such a way that information contained in the historical random access record includes one or more of the following:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the first sending module is further configured in such a way that the random access configuration includes one or more of the following:

a configuration of a random access type selected by the terminal; and

a configuration of a reference signal receiving power (RSRP) threshold of a downlink loss reference associated with random access.

In an example, the first sending module is further configured in such a way that the historical random access record is at least configured to determine the configuration of a reference signal receiving power (RSRP) threshold of a downlink loss reference associated with at least one random access type for the one or more terminals based on the information about the number of times of random access performed by the terminal under different random access types and/or the information about random access results of random access performed by the terminal under different random access types.

In an example, the first reception module is further configured to receive the obtaining request sent by means of a radio resource control (RRC) signaling by the base station; and

the first sending module is further configured to send the historical random access record to the base station by means of the radio resource control (RRC) signaling.

According to a fourth aspect of examples of the disclosure, provided is an apparatus for determining a random access configuration of a terminal. The apparatus is applied to a base station and includes a second sending module and a second reception module, where

the second sending module is configured to send an obtaining request for a historical random access record to the terminal; and

the second reception module is configured to receive the historical random access record associated with the obtaining request from the terminal.

In an example, the apparatus further includes a determination module, where the determination module is further configured to determine a random access configuration of one or more terminals according to the historical random access record.

In an example, the second sending module is further configured to send measurement configuration information to the terminal, and the measurement configuration information is configured to measure information associated with the historical random access record by the terminal in a random access process according to the measurement configuration information.

In an example, the second reception module is further configured in such a way that information contained in the historical random access record includes one or more of the following:

record information that the terminal selects a four-step random access type in a historical random access process;

record information that the terminal selects a two-step random access type in a historical random access process;

information about reference signal receiving power (RSRP) of a downlink loss reference during historical random access;

information about a reference signal receiving power (RSRP) threshold of the downlink loss reference of a random access type selected during historical random access;

information about the number of times a random access is performed by the terminal under different random access types;

information about random access results of random access performed by the terminal under different random access types;

information about random access preambles selected by the terminal for random access under different random access types;

information about random access resources selected by the terminal for random access under different random access types; and

information about identity documents (IDs) of base stations selected and accessed by the terminal for random access under different random access types.

In an example, the second reception module is further configured in such a way that the random access configuration includes one or more of the following:

a configuration of a random access type selected by the terminal; and

a configuration of a reference signal receiving power (RSRP) threshold of a downlink loss reference associated with random access.

In an example, the determination module is further configured to determine the configuration of a reference signal receiving power (RSRP) threshold of a downlink loss reference associated with at least one random access type for the one or more terminals based on the information about the number of times of random access performed by the terminal under different random access types and/or the information about random access results of random access performed by one or more terminals under different random access types.

In an example, the second sending module is further configured to send the obtaining request for the historical random access record to the terminal by means of a radio resource control (RRC) signaling; and

the second reception module is further configured to receive the historical random access record from the terminal by means of the radio resource control (RRC) signaling.

In examples of the disclosure, an obtaining request, sent by a base station, for a historical random access record is received; and the historical random access record associated with the obtaining request is sent to the base station. In this way, the base station may obtain a random access condition of the terminal according to the historical random access record obtained from the terminal, so as to determine a random access configuration of the terminal according to the historical random access record. Thus, the random access configuration may better adapt to a random access requirement of the terminal and/or the random access condition of a current position of the terminal. Compared with a fixed random access configuration used by the terminal for random access, a random access configuration determined according to the historical random access record of the terminal for random access has a higher success rate and better stability.

1. A method for determining a random access configuration of a terminal, performed by the terminal and comprising:
receiving an obtaining request, sent by a base station, for a historical random access record; and
sending the historical random access record associated with the obtaining request to the base station.

2. The method according to claim 1, wherein the historical random access record is used at least for the base station to determine a random access configuration of one or more terminals.

3. The method according to claim 1, further comprising:
receiving measurement configuration information sent by the base station; and
measuring information associated with the historical random access record in a random access process according to the measurement configuration information.

4. The method according to claim 3, wherein information contained in the historical random access record comprises at least one of:
record information that the terminal selects a four-step random access type in a historical random access process;
record information that the terminal selects a two-step random access type in a historical random access process;
information about reference signal receiving power (RSRP) of a downlink loss reference during historical random access;
information about an RSRP threshold of the downlink loss reference of a random access type selected during historical random access;
information about a number of times of random access performed by the terminal under different random access types;
information about random access results of random access performed by the terminal under different random access types;
information about random access preambles selected by the terminal for random access under different random access types;
information about random access resources selected by the terminal for random access under different random access types; or
information about identity documents (IDs) of base stations selected and accessed by the terminal for random access under different random access types.

5. The method according to claim 2, wherein the random access configuration comprises at least one of:
a configuration of a random access type selected by the terminal; and/or
a configuration of an RSRP threshold of a downlink loss reference associated with random access.

6. The method according to claim 4 or 5, wherein the historical random access record is at least configured to determine the configuration of an RSRP threshold of a downlink loss reference associated with at least one random access type for the one or more terminals based on information about a number of times of random access performed by the terminal under different random access types or information about random access results of random access performed by the terminal under different random access types.

7. The method according to claim 1, wherein receiving the obtaining request, sent by the base station, for the historical random access record comprises:
receiving the obtaining request sent by means of a radio resource control (RRC) signaling by the base station; and
sending the historical random access record associated with the obtaining request to the base station comprises:
sending the historical random access record to the base station by the RRC signaling.

8. A method for determining a random access configuration of a terminal, performed by a base station and comprising:
sending an obtaining request for a historical random access record to the terminal; and
receiving the historical random access record associated with the obtaining request from the terminal.

9. The method according to claim 8, further comprising:
determining a random access configuration of one or more terminals according to the historical random access record.

10. The method according to claim 8, further comprising:
sending measurement configuration information to the terminal, wherein the measurement configuration information is configured to measure information associated with the historical random access record by the terminal in a random access process according to the measurement configuration information.

11. The method according to claim 10, wherein information contained in the historical random access record comprises at least one of:
record information that the terminal selects a four-step random access type in a historical random access process;
record information that the terminal selects a two-step random access type in a historical random access process;
information about RSRP of a downlink loss reference during historical random access;
information about an RSRP threshold of the downlink loss reference of a random access type selected during historical random access;
information about a number of times of random access performed by the terminal under different random access types;
information about random access results of random access performed by the terminal under different random access types;
information about random access preambles selected by the terminal for random access under different random access types;
information about random access resources selected by the terminal for random access under different random access types; or
information about identity documents (IDs) of base stations selected and accessed by the terminal for random access under different random access types.

12. The method according to claim 9, wherein the random access configuration comprises at least one of:
a configuration of a random access type selected by the terminal; or
a configuration of an RSRP threshold of a downlink loss reference associated with random access.

13. The method according to claim 11, wherein determining the random access configuration of one or more terminals according to the historical random access record comprises:
determining a configuration of an RSRP threshold of a downlink loss reference associated with at least one random access type for the one or more terminals based on the information about the number of times of random access performed by the terminal under different random access types and/or the information about random access results of random access performed by one or more terminals under different random access types.

14. The method according to claim 8, wherein sending the obtaining request for the historical random access record to the terminal comprises:
sending the obtaining request for the historical random access record to the terminal by means of a radio resource control (RRC) signaling; and
the receiving the historical random access record associated with the obtaining request from the terminal comprises:
receiving the historical random access record from the terminal by the RRC signaling.

15-28. (canceled)

29. A communication device, comprising:
an antenna;
a memory; and
a processor connected to the antenna and the memory separately, configured to control receiving and sending of the antenna by executing a computer-executable instruction stored in the memory, and capable of implementing the method according to any one of claim 8.

30. A non-transitory computer storage medium, storing a computer-executable instructions, wherein the computer-executable instructions when executed by a processor cause the processor to execute the method according to claim 1.

31. A communication device, comprising:
an antenna;
a memory; and
a processor connected to the antenna and the memory separately, is configured to:
receive an obtaining request, sent by a base station, for a historical random access record; and
send the historical random access record associated with the obtaining request to the base station.

32. The communication device according to claim 31, wherein the historical random access record is used at least for the base station to determine a random access configuration of one or more terminals.

33. The communication device according to claim 31, the processor is further configured to:
receive measurement configuration information sent by the base station; and
measure information associated with the historical random access record in a random access process according to the measurement configuration information.

34. A non-transitory computer storage medium, storing a computer-executable instructions, wherein the computer-executable instructions when executed by a processor cause the processor to execute the method according to claim 8
